(19) United States
(12) Patent Application Publication
(10) Pub. No.: US 2007/0202886 A1
(43) Pub. Date: Aug. 30, 2007

(54) Location-specific broadcast messaging

(76) Inventors: Pratik Mahesh Dhebri, San Diego, CA (US); Hai Qu, San Diego, CA (US); Rex Chen, Cerritos, CA (US)

Correspondence Address: QUALCOMM INCORPORATED, 5775 MOREHOUSE DR., SAN DIEGO, CA, 92121, US

(21) Appl. No.: 11/361,159

(22) Filed: Feb. 24, 2006

(51) Int. Cl. H04Q 7/20

(52) U.S. Cl. 455/456.1

(57) ABSTRACT

An SMS CBS message includes location information that defines a relevant geographic area. A receiving device that is location aware is configured to receive the SMS CBS message and announce the message if the receiving device is within the relevant geographic area.

### BACKGROUND OF THE INVENTION

1. Technical Field

The invention relates generally to the field of wireless data transmission, and more particularly to data transmission in mobile devices.

2. Background Discussion

Mobile devices today are capable of performing many tasks. Conventional mobile devices include the capability of sending data and receiving data at the device, such as text messaging, email, and web browsing. Conventional mobile devices commonly operate within a cellular network. A cellular network is commonly composed of very many “cells” that are each interconnected to form a much larger network. A “cell” is essentially a relatively-small geographic area serviced by a particular cellular tower or service station.

Typically, a cellular network includes a Short Message Service (SMS) Cell Broadcast Service (CBS). The SMS CBS provides an efficient way for the network to propagate or broadcast information to a particular cell broadcast area. The network broadcasts a single message to any receivers able to receive a communication from the network that are within a particular geographic area covered by one or more cells. An SMS CBS message bay be broadcast to the entire network or a given area covered by one cell or multiple cells. In other words, SMS CBS is designed for simultaneous delivery of messages to multiple recipients in a specified area. Whereas conventional SMS is a one-to-one and one-to-few service, cell broadcast is a one-to-many service. Broadcasting enables messages to be communicated to multiple mobile phone customers who are located within a given part of a network coverage area at the time the message is broadcast.

Although an efficient mechanism for delivering messages to users in a particular geographic area, cell broadcast messages are not that widely used. Perhaps one reason cell broadcast messages are not widely used is because of the random size of cells. Conventional cell broadcast messages can be targeted to a certain cell, but some cells can be relatively large as their size is driven largely by the population density (or “user-density”) within the cell. Larger cells increase the overall efficiency of the cellular network, but decrease the value of targeting a particular cell. Users might be more receptive to broadcast messages if the user could be assured that there was a high degree of relevancy of the particular broadcast message to the user.

Unfortunately, a superior cell broadcast mechanism and technique have eluded those skilled in the art, until now.

### SUMMARY OF THE INVENTION

The invention is directed to providing information upon which an informed decision can be made about whether to announce a broadcast message. Briefly stated, a broadcast message includes location information to enable a location-aware receiving device to determine whether to display the broadcast message.

In one aspect, the invention envisions a method for handling broadcast messages within a communication system, and a computer-readable medium encoded with computer-executable instructions for performing the method. The method includes the steps of receiving a message at a mobile device, the message including identification information identifying a message-type for the message, the message additionally including a payload and location information, the location information specifying a relevant geographic area; determining a local location of the mobile device; comparing the local location to the location information to determine if the local location is within the relevant geographic area; and handling the payload at the mobile device based on whether the local location is within the relevant geographic area.

In another aspect, the invention envisions a method for sending a broadcast message within a communication system, and a computer-readable medium encoded with computer-executable instructions for performing the method. The method includes the step of sending a broadcast message to a mobile device within the communication system, the broadcast message including message type information, a payload, and location information, the location information specifying a relevant geographic area within which the payload is to be announced on the mobile device and outside of which the payload is not to be announced on the mobile device.

In yet another aspect, the invention envisions a memory for storing data for access by an application program being executed on a data processing system. The stored data includes a first data structure stored in the memory. The first data structure includes a plurality of data fields, including a service identification field that identifies the first data structure as a broadcast message; a payload portion that includes a payload; and a location info field that includes location information that specifies a geographic area in which the payload is relevant.

In still another aspect, the invention envisions a computer-readable medium encoded with computer-readable components. The components include a message queue configured for storing received broadcast messages; an SMS engine configured to receive messages and determine whether each received message is a broadcast message based on whether a message service identifier is associated with the message, the SMS engine further configured to store the received messages at the message queue if the message is the broadcast message; a stored settings database including user settings; a user interface configured to format and present user information; and a broadcast message engine configured to retrieve the stored broadcast message and the stored user settings, the broadcast message engine further configured to determine whether to pass the user information to the user interface based on the contents of the broadcast message and the user settings, the broadcast message engine further configured to determine whether to pass the user information to the user interface based on a comparison of a local location to a relevant geographic area specified in the broadcast message.

### BRIEF DESCRIPTION OF THE DRAWINGS

FIG. 1 is a functional block diagram generally illustrating a communication system in which implementations of the invention are particularly applicable.

FIG. 2 is a functional block diagram generally illustrating an SMS broadcast message in accordance with one implementation of the invention.

FIG. 3 is a functional block diagram generally illustrating an application execution environment in accordance with one implementation of the invention.

FIG. 4 is a functional block diagram generally illustrating a mobile device in which implementations of the invention are particularly applicable.

FIG. 5 is an operational flow diagram generally illustrating a process for replying to SMS cell broadcast messaging that further illustrates including location information within the SMS cell broadcast message.

### DETAILED DESCRIPTION

What follows is a detailed description of various techniques and mechanisms for wireless data transmission. Very generally stated, the present invention is directed to providing location-based cell broadcast capability. A special field is included in a broadcast message and specifies a geographic area of relevance for the broadcast message. A mobile device determines whether to accept the broadcast message based on whether the mobile device is within the specified geographic area.

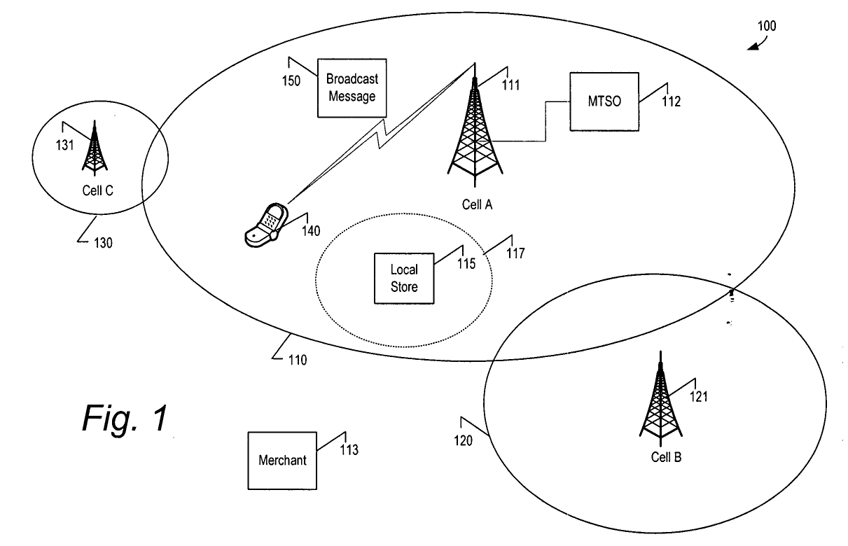

FIG. 1 is a functional block diagram generally illustrating a communication system 100 in which implementations of the invention are particularly applicable. Communication system 100 is a cellular communication network for transmitting and receiving voice and/or data communication to mobile devices. Communication system 100, as shown, includes three cells, cell A 110, cell B 120, and cell C 130. Each cell is a subordinate communication network of the larger communication system 100 for facilitating communications within an associated geographic area. Each cell includes hardware, such as a tower 111, 121, and 131 and software to facilitate two-way communication within the associated geographic area. Each cell is coupled to the other cells to facilitate communication between a mobile device in one cell and other devices, such as other mobile devices in the same or another cell, or wired devices on the Public Switched Telephone Network (PSTN) or the Public Land Mobile Network (PLMN) in the case of mobile devices compatible with the GSM/UMTS standards.

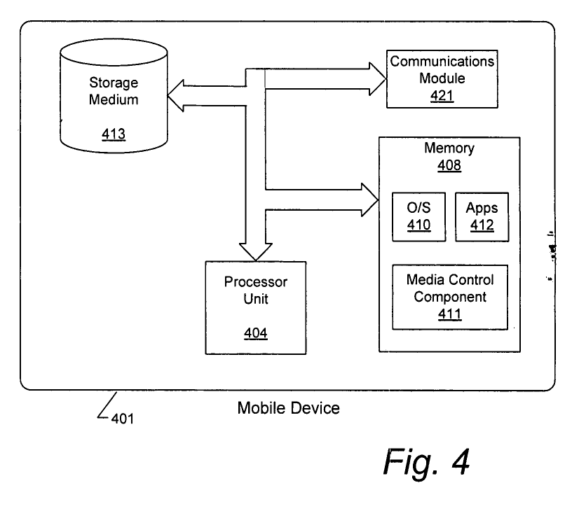

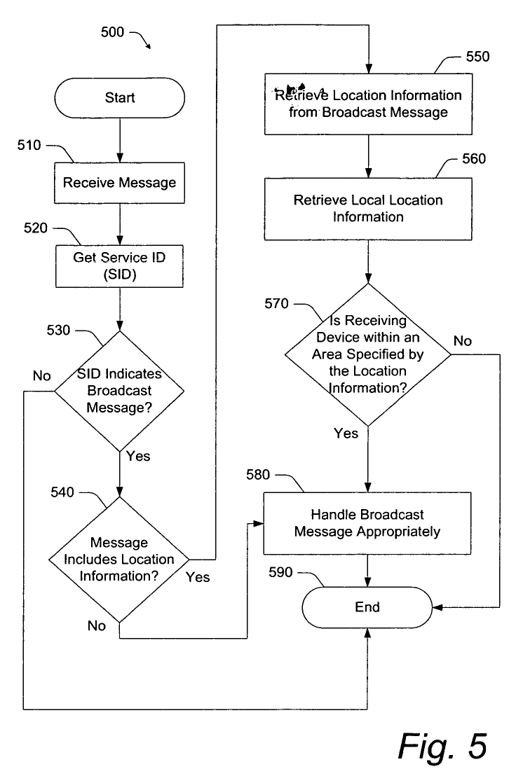

Communication system 100 includes a mobile device 140, such as a cellular telephone. Mobile device 140 is a two-way telecommunications device that is compatible with communication system 100 and, as illustrated, is currently operating within cell A 110 of communication system 100. Mobile device 140 is configured for voice communication as well as data communication, such as sending and receiving SMS messages. The mobile device 140 further includes functionality for use in determining whether to accept or announce an incoming message based on information within the message. One particular embodiment of mobile device 140 is illustrated in FIG. 4 and described in greater detail below.

A merchant 113 represents any entity or individual that desires to disseminate information. For instance, perhaps the merchant 113 is a vendor or retailer that would like to announce a sale or promotion. Many other examples are also possible. The merchant 113 may have many business locations, including a local store 115 that resides within the general geographic area of cell A 110. However, and more importantly, the local store 115 may reside within a particular geographic area of relevance 117.

The relevant geographic area 117 is defined by the merchant 113 (or the merchant's representative). The relevant geographic area 117 represents an area within which it is believed that information will be relevant to a user of the communication system 100. For example, perhaps the merchant 113 is conducting a promotion and would like to convey information about the promotion to any user near the local store 115, where ‘near’ is defined as being within the relevant geographic area 117. Notably, the relevant geographic area 117 falls within the footprint of one or more cells, cell A 110 in this example, but this is not necessary. The relevant geographic area 117 can be described using geospatial terms, such as latitude, longitude, and elevation. In addition, although illustrated as oval in shape, it should be appreciated that the relevant geographic area 117 can be shaped in any arbitrary manner limited only by the ability to describe the area using geospatial terms. For instance, the relevant geographic area 117 could be specified such that it precisely overlays a given number of city blocks, or a particular number of meters from a center point, or the like.

Communication system 100 additionally includes a mobile telephone switching office (MTSO) 112. The MTSO 112 is located within cell A 110 in this example. However, in other examples, the MTSO 112 may be located elsewhere within the communication system 100, such as cell B 120, cell C 130, or elsewhere. The MTSO 112 is a central switch that controls communications within a cellular sub-system which typically encompasses several cells. For instance, the MTSO 112 in this example controls communications for any devices within cell A 110, cell B 120 or cell C 130. In one embodiment, the MTSO 112 is implemented as a computer system that monitors cellular calls, tracks the location of cellular devices (e.g. cellular-equipped vehicles, hand-carried mobile phones or cellular-equipped PDA devices, etc.) stationary or traveling in the system, arranges handoffs (e.g., between cells within the system), keeps track of billing information, and the like.

In this implementation, the MTSO 112 further supports SMS Cell Broadcast Service (CBS) functionality that allows for the creation and distribution of broadcast messages (such as broadcast message 150). Briefly stated, the MTSO 112 creates a special message that is designated for distribution as a broadcast message. Then, the MTSO 112 causes that broadcast message to be distributed by one or more particular cellular sub-networks. In this example, the MTSO 112 causes one particular broadcast message 150 to be distributed over cell A 110 using tower 111. The broadcast message 150 could equally have been targeted at any one or more other cells either in addition to or in lieu of cell A 110.

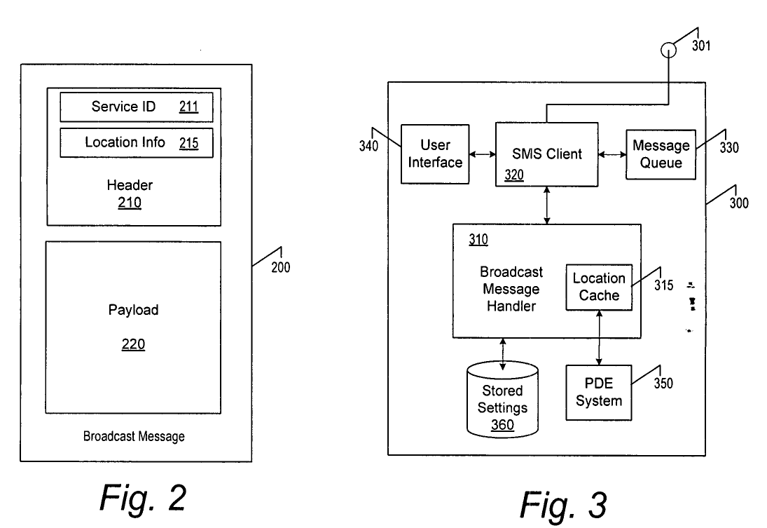

In accordance with this embodiment of the invention, the broadcast message 150 is an SMS CBS message that specifies a location within which the message 150 is relevant. One particular embodiment of broadcast message 150 is illustrated in FIG. 2 and described in further detail below. Generally described, the broadcast message 150 includes location information that can be used by a receiving device (e.g., mobile device 140) in a determination whether to accept or announce the broadcast message 150.

In general operation, the merchant 113 cooperates with the MTSO 112 for the creation and dissemination of the broadcast message 150. The merchant 113 specifies the relevant geographic area 117 in which the broadcast message 150 either should be announced on a receiving device, or perhaps should not be announced. MTSO 112 prepares and configures the broadcast message 150 for broadcast transmission by one or more cells, such as cell A (110) in this example. The MTSO 112 causes the cell A tower 111 to propagate the broadcast message 150 throughout the geographic area serviced by cell A 110. Thus, any capable mobile device within cell A 110, mobile device 140 in this example, may receive the broadcast message 150.

When received, the mobile device 140 analyzes the broadcast message 150 to determine whether to announce the message. As described in greater detail below, the mobile device 140 extracts from the broadcast message 150 the location information that specifies the relevant geographic area 117. The mobile device 140 also determines its own geographic location using any appropriate mechanism, such as a Global Positioning Satellite receiver. The mobile device 140 compares its location to the location information specified in the broadcast message 150 and announces the message if the mobile device 140 is within the relevant geographic area 117.

The concept has been presented here in general terms to provide the reader with a conceptual understanding of this implementation of the invention. Additional detail about this implementation will now be presented with reference to certain components of the above-described system.

FIG. 2 is a functional block diagram generally illustrating a broadcast message 200 in accordance with one implementation of the invention. In this implementation, the broadcast message 200 is an SMS Cell Broadcast (CB) message that includes location information. In this example, broadcast message 200 includes a payload 220 that contains information to be provided to a user of a device receiving broadcast message 200. For instance, the payload may include information (e.g., text and graphics) that constitute an advertisement, a promotion, a survey, or the like. This information may also have particular relevance to a certain definable geographic area (the area of relevance).

Broadcast message 200 additionally includes a header 210 having several fields, such as service ID field 211 and location information field 215. The several fields of the header 210 may include information for routing the message 200 through a communication system. Certain fields within header 210 provide specific data that identifies broadcast message 200 to a recipient device (not shown) and/or provides instruction to the recipient device.

The service ID field 211 includes data identifying the broadcast message 200 as a broadcast message, from the universe of available messages, to the recipient device. More specifically, the existence of the service ID field 211 may indicate to a receiving device that the message 200 is a broadcast message, and the service ID field 211 may include information that specifies the type of information presented in the payload 220. For example, the payload 220 may include sports-related information, advertisements, financial information, or the like. Each of those different types of information many be associated with a “channel” (sometimes referred to as a “topic”), and each channel may have a corresponding identifier. The channel identifier that describes the information in the payload 220 may be included in the service ID field 211. In one specific example, assume that the payload 220 includes promotional information which falls into an “advertising” channel having a channel identifier of “1234.” In that example, the broadcast message 200 would include a service ID field 211 that contains the channel identifier of “1234.”

Of particular importance is a location information field 215, which includes data identifying at least one relevant area for the message 200. As discussed above in conjunction with FIG. 1, there may be a geographic area in which the broadcast message 200 is of particular relevance. In such a case, location information may be included in the location information field 215 that specifies that relevant geographic area. The relevant geographic area could be a substantially circular area, such as a circular area centered around a point like a shopping mall or the like. Alternatively, the geographic area could be given a particular shape, such as a substantially rectangular area covering certain city blocks or the like. In addition, multiple relevant geographic areas could be specified in the location information field 215. The location information could be described with conventional geospatial terms, such as latitude, longitude, elevation, any combination of these, or the like. The location information field 215 could also specify whether the relevant geographic area is inclusive or exclusive, meaning that the payload of the message is only relevant if the mobile device is either inside or outside, respectively, the relevant geographic area(s).

FIG. 3 is a functional block diagram generally illustrating an application execution environment 300 in which implementations of the invention are particularly applicable. Application execution environment 300 may be a system for executing software on a mobile device, or the like. In this embodiment, application execution environment 300 includes components to facilitate receiving broadcast messages within an SMS CBS communication system.

An SMS client 320 provides general control functions for transmitting and receiving messages over a messaging transport, such as the SMS messaging protocol in common use today. The SMS client 320 may transmit and receive the messages to and from a communications component 301, and store any received messages in a message queue 330 for processing.

SMS client 320 determines a message type for each received message based on information contained within the message, such as particular header fields or the like. For example, header fields in a received message may identify the message as a broadcast message, a point-to-point message, or some other message type. SMS client 320 may also compose messages for transmission over the messaging transport.

A user interface (U/I) 340 is a software component for formatting and presenting data to a user as well as receiving commands and input from the user. In one embodiment, the SMS client 320 formats and presents information from portions of a message (e.g., fields, payload, etc.) to a user and receives input from the user (e.g., instructions) based on the provided information using the U/I 340. For example, in a case where an advertising message has been received, the U/I 340 may be used to present that information to a user.

A Position Determination Equipment (PDE) system 350 may be included to make the mobile device on which the application execution environment 300 resides location-aware. The PDE system 350 generates location data about the geographic position of the application execution environment 300. In one embodiment, the PDE system 350 receives Global Positioning Satellite (GPS) data from a GPS receiver (not shown) and converts the received GPS data into location data (e.g., a precise geographic location). The term “PDE system” is used for simplicity of description only, and includes any type of location identification system, such as GPS, Location Based Services (LBS), Network-based Position Determination (e.g., triangulation), Angle of Arrival (AOA) method, Time of Arrival (TOA) method, Enhanced Observed Time Difference (E-OTD), Radio Propagation techniques, combinations of these, or the like.

A stored settings database 360 may also be included to store persistent data, such as user preferences. For instance, the user preferences may specify whether to and which received broadcast messages to present to a user. More specifically, the user preferences could include a listing of any channel identifiers for which the user has indicated a desire to receive messages. For example, the user may have set up the application execution environment 300 so that any advertisements or the like are only to be announced if the user is within a relevant geographic area, but not otherwise.

Broadcast message handler 310 is a component for evaluating received broadcast messages for content and, when appropriate, announcing the received broadcast message using the user interface. Broadcast message handler 310 is in communication with SMS client 320 as well as stored settings database 360. In one embodiment, broadcast message handler 310 is notified by the SMS client 320 when broadcast messages are received. In this embodiment, broadcast message handler 310 determines whether to present the payload portion of the broadcast message to a user based on information contained within headers of the broadcast message and the user settings in the settings database 360. If the user settings allow, the broadcast message handler 310 passes the payload of the broadcast message to the U/I 340 for presentation to a user.

More specifically, the broadcast message handier 310 may include a location cache 315, in which is stored location data received from the PDE system 350. The broadcast message handler 310 may use data in the location cache 315 to determine if the user has authorized the type of message (e.g., by service ID) and if the mobile device is within any geographic area specified within the broadcast message. If such determinations are positive, the broadcast message handler 310 handles the broadcast message appropriately, such as perhaps by displaying with the U/I 340 a location-appropriate message, or the like.

FIG. 4 is a functional block diagram generally illustrating a sample mobile device 401 in which implementations of the invention are particularly applicable. The mobile device 401 may be any handheld computing device, such as a cellular telephone, a personal digital assistant, a portable music player, a global positioning satellite (GPS) device, or the like. Although described here in the context of a handheld computing device, it should be appreciated that implementations of the invention could have equal applicability in other areas.

In this example, mobile device 401 includes a processor unit 404, a memory 408, and a storage medium 413. The processor unit 404 advantageously includes a microprocessor or a special-purpose processor such as a digital signal processor (DSP), but may in the alternative be any conventional form of processor, controller, microcontroller, or state machine. Mobile device 401 may also include additional components not relevant to the present discussion.

The processor unit 404 is coupled to the memory 408, which is advantageously implemented as RAM memory holding software instructions that are executed by the processor unit 404. In this embodiment, the software instructions stored in the memory 408 include one or more applications 412, a media control component 411, and an operating system 410. The memory 408 may be on-board RAM, or the processor unit 404 and the memory 408 could collectively reside in an Application Specific Integrated Circuit (ASIC). In an alternate embodiment, the memory 408 may be composed of firmware or flash memory, such as a SmartMedia card.

The processor unit 404 is also coupled to the storage medium 413, which may be implemented as any nonvolatile memory, such as ROM memory, flash memory, or a magnetic disk drive, just to name a few. The storage medium 413 may also be implemented as any combination of those or other technologies, such as a magnetic disk drive with cache (RAM) memory, or the like. In this particular embodiment, the storage medium 413 is used to store data during periods when the mobile device 401 may be powered off or without power.

The mobile device 401 also includes a communications module 421 that enables bidirectional communication between the mobile device 401 and one or more other computing devices. The communications module 421 may include components to enable RF or other wireless communications, such as a cellular telephone network, Bluetooth connection, wireless local or wide area network, or perhaps a Global Positioning Satellite receiver. Alternatively, the communications module 421 may include components to enable land line or hard wired network communications, such as an Ethernet connection, universal serial bus connection, IEEE 1394 (Firewire) connection, or the like. These are intended as non-exhaustive lists and many other alternatives are possible.

FIG. 5 is an operational flow diagram generally illustrating a method 500 for handling an SMS CBS message that includes location information. In one embodiment, method 500 is implemented with components, data, and/or the exemplary operating environments of FIGS. 1-4. Although the method 500 illustrated in FIG. 5 may be described with reference to components shown in FIGS. 1-4, it should be understood that this is merely for convenience and alternative components can also be employed to implement the method 500.

Preferably, one or more steps of method 500 are embodied in a computer-readable medium containing computer-readable code such that a series of steps are implemented when the computer-readable code is executed on a computing device. In some implementations, certain steps of method 500 are combined, performed simultaneously or in a different order, or perhaps omitted, without deviating from the spirit of method 500.

Method 500 begins at step 510. At step 510, it is determined that a message has been received. In one embodiment, the message is received at a mobile device within a wireless operating environment. In an example and referring to FIGS. 1 and 3 above, a message (e.g., broadcast message 150) is received at mobile device 140 from tower 111 when mobile device 140 is operating within Cell A (110). Continuing the example, when the message is received at the mobile device, the message is received at SMS client 320 operating within application execution environment 300.

At step 520, a service identification (SID) is retrieved from the received message. In one embodiment, each message includes a header portion and a payload portion. In this embodiment, the SID is retrieved from the header portion of the received message. In an example and referring to FIGS. 2 and 3 above, SMS client 320 retrieves the SID from the SID field 211 of header 210 within message 200.

At decision step 530, it is determined whether the SID retrieved in step 520 above is associated with an SID that has been approved for announcement. More specifically, the SID may include a channel identifier that corresponds to some type of information. If a user has approved the announcement of information having the channel identifier within the SID, the method 500 continues to decision step 540. Alternatively, if the SID identifies the message as being in a channel that is not approved, the method 500 ends at step 590.

At decision step 540, it is determined whether the received broadcast message includes location information. In one embodiment, a message is determined to include location information when it includes a location information field, such as location information field 215 of broadcast message 200 of FIG. 2, above. In an example and referring to FIG. 3 above, broadcast message handler 310 inspects the retrieved broadcast message for a location information field 215 containing location data. If it is determined that the received message includes location information, the method 500 continues to step 550. If it is determined that the received message does not include location information, the method 500 continues to step 580.

At step 550, location information is retrieved from the broadcast message. In one embodiment, the location information is included within a location information field of the broadcast message. In this embodiment, the location information specifies a relevant geographic area using any appropriate geospatial terms, such as latitude, longitude, and perhaps elevation. The relevant geographic area also may be defined or specified in any meaningful way, such as by defining four corners of a polygon, by defining a center point and a radius, or in any other meaningful way. In an example and referring to FIGS. 2 and 3 above, broadcast message handler 310 retrieves the location information from the location information field 215 of header 210 within message 200.

At step 560, local location information is retrieved. In one embodiment, current location information is retrieved from a local source, such as from an on-board PDE system. In an example and referring to FIG. 3 above, broadcast message handler 310 retrieves current location information from location cache 315 within broadcast message handler 310. In this example, location cache 315 receives current location information updates from PDE system 350, such as on a regular interval basis, when PDE system 350 determines a change in location, is informed of a change in location, or the like.

At decision step 570, it is determined whether the receiving device is within the relevant geographic area specified by the location information received within the broadcast message. In one embodiment, the local location of the receiving mobile device is compared to the specified relevant geographic area to determine whether the receiving mobile device is located within the relevant geographic area. If it is determined that the receiving device is not within the specified area, the method 500 ends at step 590. If it is determined that the receiving device is within the specified area, the method 500 continues to step 580.

At step 580, the broadcast message is handled in accordance with the payload of the broadcast message. For instance, if the payload of the message includes information about a sale or promotion at a particular store, and it has been determined that the mobile device is within the relevant geographic area, the mobile device may announce the broadcast message to the user. There are very many different alternatives for announcing the broadcast message, such as simply rendering the payload of the message on a display of the mobile device, playing an audible sound (e.g., a ringtone), flashing lights, or the like. Other examples will be apparent.

When the broadcast message has been appropriately handled, the method 500 ends at step 590.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

We claim:

1. A method for handling broadcast messages within a communication system, comprising:
receiving a message at a mobile device, the message including identification information identifying a message-type for the message, the message additionally including a payload and location information, the location information specifying a relevant geographic area;
determining a local location of the mobile device;
comparing the local location to the location information to determine if the local location is within the relevant geographic area; and
handling the payload at the mobile device based on whether the local location is within the relevant geographic area.

2. The method recited in claim 1, wherein handling the payload comprises announcing the message at the mobile device.

3. The method recited in claim 1, wherein handling the payload comprises not announcing the message at the mobile device.

4. The method recited in claim 1, wherein the communication system is a cellular network.

5. The method recited in claim 1, wherein the broadcast message is received using a Short Messaging Service (SMS) protocol.

6. The method recited in claim 5, wherein the broadcast message is received using an SMS Cell Broadcast Service.

7. The method recited in claim 1, wherein the broadcast message includes a header portion and a payload portion, the header portion including the location information, the payload portion including the payload.

8. A method for sending a broadcast message within a communication system, comprising:
sending a broadcast message to a mobile device within the communication system, the broadcast message including message type information, a payload, and location information, the location information specifying a relevant geographic area within which the payload is to be announced on the mobile device and outside of which the payload is not to be announced on the mobile device.

9. The method recited in claim 8, wherein the communication system is a cellular network.

10. The method recited in claim 8, wherein sending the broadcast message is performed in accordance with a Short Messaging Service (SMS) protocol.

11. The method recited in claim 10, wherein sending the broadcast message is performed using an SMS Cell Broadcast Service.

12. The method recited in claim 8, wherein the broadcast message includes a header portion and a payload portion, the header portion including the message type information and the location information, the payload portion including the payload.

13. A memory for storing data for access by an application program being executed on a data processing system, comprising:
a first data structure stored in the memory, the first data structure including a plurality of data fields, the plurality of data fields including:
a service identification field that identifies the first data structure as a broadcast message;
a payload portion that includes a payload; and
a location info field that includes location information that specifies a geographic area in which the payload is relevant.

14. The memory recited in claim 13, wherein the first data structure comprises a broadcast message.

15. The memory recited in claim 14, wherein the broadcast message conforms to a Short Messaging Service (SMS) format.

16. The memory recited in claim 15, wherein the broadcast message conforms to an SMS Cell Broadcast Service format.

17. The memory recited in claim 13, wherein the location information comprises geospatial identification data.

18. The memory recited in claim 17, wherein the geospatial identification data comprises a latitude and a longitude.

19. The memory recited in claim 18, wherein the geospatial identification data further comprises an elevation.

20. The memory recited in claim 17, wherein the geospatial identification data comprises a set of points that define a geographic area.

21. The memory recited in claim 17, wherein the geospatial identification data comprises at least one point and a radius that define a geographic area.

22. A computer-readable medium encoded with computer-executable instructions for handling broadcast messages within a communication system, the instructions comprising:
receiving a message at a mobile device, the message including identification information identifying a message-type for the message, the message additionally including a payload and location information, the location information specifying a relevant geographic area;
determining a local location of the mobile device;
comparing the local location to the location information to determine if the local location is within the relevant geographic area; and
handling the payload at the mobile device based on whether the local location is within the relevant geographic area.

23. The computer-readable medium recited in claim 22, wherein handling the payload comprises announcing the message at the mobile device.

24. The computer-readable medium recited in claim 22, wherein handling the payload comprises not announcing the message at the mobile device.

25. The computer-readable medium recited in claim 22, wherein the communication system is a cellular network.

26. The computer-readable medium recited in claim 22, wherein the broadcast message is received using a Short Messaging Service (SMS) protocol.

27. The computer-readable medium recited in claim 26, wherein the broadcast message is received using an SMS Cell Broadcast Service.

28. The computer-readable medium recited in claim 22, wherein the broadcast message includes a header portion and a payload portion, the header portion including the location information, the payload portion including the payload.

29. A computer-readable medium encoded with computer-executable instructions for sending a broadcast message within a communication system, the instructions comprising:
sending a broadcast message to a mobile device within the communication system, the broadcast message including message type information, a payload, and location information, the location information specifying a relevant geographic area within which the payload is to be announced on the mobile device and outside of which the payload is not to be announced on the mobile device.

30. The computer-readable medium recited in claim 29, wherein the communication system is a cellular network.

31. The computer-readable medium recited in claim 29, wherein sending the broadcast message is performed in accordance with a Short Messaging Service (SMS) protocol.

32. The computer-readable medium recited in claim 31, wherein sending the broadcast message is performed using an SMS Cell Broadcast Service.

33. The computer-readable medium recited in claim 29, wherein the broadcast message includes a header portion and a payload portion, the header portion including the message type information and the location information, the payload portion including the payload.

34. A computer-readable medium encoded with computer-readable components, the components comprising:
a message queue configured for storing received broadcast messages;
an SMS engine configured to receive messages and determine whether each received message is a broadcast message based on whether a message service identifier is associated with the message, the SMS engine further configured to store the received messages at the message queue if the message is the broadcast message;
a stored settings database including user settings;
a user interface configured to format and present user information; and
a broadcast message engine configured to retrieve the stored broadcast message and the stored user settings, the broadcast message engine further configured to determine whether to pass the user information to the user interface based on the contents of the broadcast message and the user settings, the broadcast message engine further configured to determine whether to pass the user information to the user interface based on a comparison of a local location to a relevant geographic area specified in the broadcast message.

35. The computer-readable medium encoded with computer-readable components recited in claim 34, further comprising a position determination equipment (PDE) system configured to determine the local location.

36. An apparatus for handling broadcast messages within a communication system, comprising:
means for receiving a message at a mobile device, the message including identification information identifying a message-type for the message, the message additionally including a payload and location information, the location information specifying a relevant geographic area;
means for determining a local location of the mobile device;
means for comparing the local location to the location information to determine if the local location is within the relevant geographic area; and
means for handling the payload at the mobile device based on whether the local location is within the relevant geographic area.

37. An apparatus for sending a broadcast message within a communication system, comprising:
means for sending a broadcast message to a mobile device within the communication system, the broadcast message including message type information, a payload, and location information, the location information specifying a relevant geographic area within which the payload is to be announced on the mobile device and outside of which the payload is not to be announced on the mobile device.
